(19) United States
(12) Patent Application Publication
(10) Pub. No.: US 2026/0346513 A1
(43) Pub. Date: Nov. 5, 2026

(54) System for Producing a Panel, Method, And Panel

(71) Applicant: I4F LICENSING NV, Tumhout (BE)

(72) Inventor: Eddy Alberic Boucké, Turnhout (BE)

(21) Appl. No.: 19/488,887

(22) PCT Filed: Jun. 3, 2024
(86) PCT No.: PCT/EP2024/065235

§ 371 Date: Dec. 1, 2025

(30) Foreign Application Priority Data
Jun. 2, 2023 (NL) 2034982

(51) Int. Cl. B29C 43/22; B29C 43/30; B29C 43/46; B29C 48/00; B29C 48/305; B29L 7/00; B29L 31/10

(52) U.S. Cl. CPC B29C 43/222; B29C 43/305; B29C 43/46; B29C 48/0011; B29C 48/305; B29C 2043/461; B29C 2043/467; B29L 2007/002; B29L 2031/10

(57) ABSTRACT

The invention relates to a system for producing a panel, in particular a decorative panel, such as a floor panel, a ceiling panel or a wall panel, at least partially. The invention also relates to a method of producing a panel, in particular a decorative panel, such as a floor panel, a ceiling panel or a wall panel, at least partially, preferably by using the system according to the invention. The invention additionally relates to a panel realized by applying the method according to the invention and/or by using the system according to the invention.

### CROSS-REFERENCE TO RELATED APPLICATIONS

This application is the United States national phase of International Patent Application No. PCT/EP2024/065235 filed Jun. 3, 2024, and claims priority to The Netherlands Patent Application No. 2034982 filed Jun. 2, 2023, the disclosures of which are hereby incorporated by reference in their entireties.

### BACKGROUND OF THE INVENTION

### Field of the Invention

The invention relates to a system for producing a panel, in particular a decorative panel, such as a floor panel, a ceiling panel or a wall panel, at least partially. The invention further relates to a calendering device for use in said system according to the invention. The invention also relates to a method of producing a panel, in particular a decorative panel, such as a floor panel, a ceiling panel or a wall panel, at least partially, preferably by using the system according to the invention. The invention additionally relates to a panel realized by applying the method according to the invention and/or by using the system according to the invention.

### Description of Related Art

Decorative coverings, in particular floor coverings, are more often formed by a plurality of interconnected panels, wherein each panel has an extruded core of thermoplastic comprising core material, as these coverings typically have relatively good waterproof properties. In consideration of the increasingly stricter ecological and/or sustainability requirements or motivations for saving materials, weight and energy, amongst others, the need arises for light-weight panels, yet still with sufficient strength and shape retention and with sufficiently strong coupling or connecting profiles at their edges of the panels or tiles with adjacent panels or tiles, and which can be produced in an efficient manner.

### SUMMARY OF THE INVENTION

It is a first object of the present invention to provide an improved system and/or method for producing relatively light-weight panels, in particular a relatively light-weight interconnectable decorative panel.

It is a second object of the present invention to provide an improved system and/or method for efficiently producing different types of relatively light-weight panels, in particular different types of relatively light-weight interconnectable decorative panels.

At least one of the aforementioned objects is achieved by providing a system and/or a calendering device as described herein, said system comprising:
at least one calendering device for calendering a sheet-like panel layer, such as a sheet-like thermoplastic based panel layer, of at least one panel to be produced, said panel layer having first and second opposed major surfaces, wherein said calendering device comprises:
   at least one first axially rotatable roller mounted by a first mounting structure,
   a plurality of second axially rotatable rollers mounted by at least one second mounting structure,
   wherein at least a part of said first mounting structure and at least a part of said at least one second mounting structure are mutually displaceable to align a selective and/or selected second roller with said first roller, such that a roller nip is enclosed by said aligned first and second rollers, whereby passage of said panel layer through said roller nip causes calendering of said panel layer, and
   wherein at least one second roller preferably has a profiled outer surface to impress a corresponding pattern and/or profile into the second major surface of the panel layer.

Since the system comprises a plurality of second rollers, the desired second roller to be used for calendering can be selected and can be brought in place by simply mutually displacing the second mounting structure and the first mounting structure. Here, it is for example imaginable, and often preferred, that the first mounting structure is a stationary mounting structure and the second mounting structure is a mobile mounting structure, although an inverted embodiment is also imaginable wherein the second mounting structure is stationary and the first mounting structure is mobile. It is also imaginable that both the first mounting structure and the second mounting structure are mobile (displaceable) mounting structures. This provides great flexibility in the texture or lack of texture to be applied to the major surface(s) of the panel layer. In this way it is also not necessary to physically remove a relatively heavy second roller to subsequently install another relatively heavy second roller to be used for calendering. As the weight of such a second roller is typically a couple of hundreds kilograms, this latter would be a heavy, time-consuming, and laborious operation, wherein the risk of damaging the second roller(s) would be significant. In the system according to the present invention, preferably all second rollers are pre-installed and mounted by one or more second mounting structures, and the second roller to be used can simply be transferred mechanically to the right position with respect to the first roller to be used to form the roller nip. Preferably, bringing the selected second roller in the right place is done in a fully automated manner, more preferably by using one or more electromotors and a control unit of the calendering device and/or of the system as such.

By (mechanically) replacing the second roller by another second roller the calendering process can be influenced. In this way it is for example possible to regulate (change) the height of the roller nip, optionally in a position-selective manner, to determine the desired thickness and/or flatness of the panel layer and/or to provide at least one major surface, in particular the second major surface, of the panel layer, with a desired impressed profile and/or pattern. To this end, and as indicated above, preferably a second roller is used with a profiled outer surface.

The resulting calendered panel layer having an at least one impressed major surface, and consequently the resulting (decorative) panel comprising at least one of such a calendered panel layer, has several advantages. An important advantage is that the specific weight of said panel layer is relatively low due to the impressed profile(s), which eventually leads to a weight saving and hence to a relatively light-weight panel (compared to conventional panels), which is beneficiary from both an economic, environmental and logistic point of view. Additionally, the impressed profile or pattern may contribute to the sound dampening properties of the panel layer and/or of the resulting (decorative) panel, which is favourable during use in a commercial and/or residential area.

Applying the impressed profile (and/or pattern and/or texture) into at least one major surface of the panel layer during calendering is efficient, as no separate impressing station downstream the calendering device will be needed to realize such an impressed profiled surface. Moreover, the calendering device is preferably situated directly downstream of at least one extruder for forming/extruding the—thermoplastic based—panel layer, which means that the extruded panel layer is typically just discharged from an extruder, and therefore still in a softened and/or molten state (and having an elevated temperature), which should be understood as viscous or paste-like, which facilitates (de)formation in the calendering device. It is also imaginable to bring the core material in a softened state without extruder or without using extrusion. The extruder preferably makes part of the system according to the invention.

The sheet-like panel layer, which may be a continuous layer, calendered by using the calendering device preferably serves as basis for the formation of a plurality of panels. Preferably, the sheet-like panel layer forms constitutes at least a part of at least one core layer of a plurality of panels formed downstream the calendering device. Preferably, the second major surface of the panel layer will be the lower surface of the panel layer. Once the panel has been realized in its entirety, the impressed second major surface of the panel layer may constitute the bottom surface of the panel as such. It is also imaginable that the second major surface is covered by another layer, such as a backing layer, in the panel to be eventually formed. Consequently, the first major surface of the panel layer is preferably the upper side of the panel layer. Preferably, this first major surface is covered by one or more further layers of the panel, such as a laminated decorative top structure which is preferably affixed, either directly or indirectly, to the first major surface of the calendered panel layer.

Preferably, at least one first roller has a flat (unprofiled) outer contact surface, which results in a flat first major surface of the panel layer during calendering. This may be favourable for applying a decorative top structure, directly or indirectly, on top of the major surface of the calendered panel layer. As indicated above, preferably at least one second roller has a profiled outer contact surface to impress a counter-profile (complementary profile or inverted profile) into the second major surface of the panel layer. The counter-profile to be impressed into the second major surface of the panel may vary per second roller. It is imaginable that the second roller to be applied is dependent on the panel type and/or the panel thickness. To easily and quickly switch between second rollers, it is favourable that at least a part of said first mounting structure and at least a part of said at least one second mounting structure are mutually displaceable to align a selective and/or selected second roller with said first roller. Here, the first mounting structure is preferably formed of and/or comprises a carousel (preferably rotatable around a horizontal axis). Further details of this preferred carousel construction as mounting structure are given below. Preferably, the calendering device comprises at least two second rollers having a profiled outer surface, wherein the profiled outer surfaces of said second rollers mutually differ. In this manner, the counter-profile to be impressed into the second major surface can be chosen. Preferably, the profile on the outer surface of at least one second roller defines at least one pattern, and more preferably a plurality of impression patterns. Preferably, the length and/or width of each panel to be produced based upon said panel layer exceeds the length and/or width of each impression pattern. In this manner, the edges of the panel can remain free from any impressed profile, which allows the edges, and possibly any coupling profiles located at one or more of said edges, to be shaped in a relatively robust (unweakened) manner. For thicker panel, having a thickness of at least 5 mm, preferably at least 6 or at least 7 mm, the impression patterns may extend to one or more panel edges, although in general it is typically preferred to position the impression pattern(s) at a distance from the panel edges. In case one or more edges are provided with coupling profiles, such as tongue and/or groove based coupling profiles, a robust edge, and hence a robust coupling profile, allows two and more panels to be coupled to each other in a relatively firm, reliable and/or durable manner.

Keeping the impressed pattern (or profile) at a distance from the edges is for example possible by providing the outer surface of the second roller with an circumferentially interrupted pattern and/or by providing a plurality of patterns mutually spaced in a longitudinal direction of the second roller. The depth of the impression pattern(s) is preferably situated between 0.05 and 2 mm. to this end, the outer surface of the textured (second and/or first) roller is provided with protrusions having substantially the same dimensioning. Hence, in this preferred embodiment, the outer surface of the textured (second and/or first) roller is provided with protrusions having a height of between 0.05 and 2 mm. Preferably, at least 50% of the impression pattern has a depth of between 0.5 and 2 mm. It is imaginable that the depth of the impression pattern varies across the pattern. It is imaginable that the depth of the impression pattern is less deep at one or more edges (peripheral zone(s)) of the impression pattern compared to the pattern depth in a center region (center zone) of the pattern. It is imaginable that the depth of the impression pattern varies within a center zone of the impression pattern. This latter variation may be a random variation (unstructured variation) or may be a gradual variation (structured variation).

An example of a profiled outer surface of a second roller is a profiled outer surface which comprises at least one set of plurality of parallel, preferably linear, recessed and/or protruding tracks (ridges and/or channels). Such a profile will result into impressed parallel channels (grooves) into the second major surface of the panel layer. As indicated above, these channels are preferably positioned at a distance at least two opposite edges, more preferably at a distance of all edges of the panel eventually formed based upon said panel layer. Additionally or alternatively, at least one profiled outer surface of at least one second roller may comprise at least one matrix and/or honeycomb and/or waffle based profile and/or may comprises one or more protruding knobs or beads, preferably arranged in a pattern, and preferably having a polygonal cross-section. This will typically result in impressed cavities, in particular cells, with a polygonal cross-section, such as a square, rectangular, pentagonal, or hexagonal cross-section. The cavities are preferably oriented side-by-side, wherein the cavities are typically defined by one or more circumferential cavity walls. Each cavity wall preferably is a shared cavity wall spacing adjacent cavities.

Preferably, the cavity walls together define a grid enclosing the cavities. Preferably, the width of the cavity walls is situated between 2 and 3.5 mm, more preferably between 2.5 and 3 mm. Preferably, the (smallest) cavity width of at least a number of cavities is situated between 5 and 20 mm, preferably between 7.5 and 15 mm, more preferably approximately 1 mm. This will lead to a serious reduction of the material needed to compose the panel layer, while securing sufficient layer stability, in particular layer rigidity, during use. Moreover, this will typically improve the acoustic sound dampening properties of the core. These advantages can further be improved in case, as preferred, the cavity depth exceeds the smallest cavity width. Moreover, the grid like second major surface of the panel layer, in particular in case this second major surface faces down, may also improve the anti-slip properties of the panel, meaning that the panel will be less inclined to move over an underfloor once installed in a floating manner, and during normal use. Furthermore, the grid like second major surface of the panel layer, in particular in case this second major surface faces down, has a reduced lower footprint (reduced contact surface) for—if applied—adhering a backing layer to said panel layer, which requires less, and hence leads to a saving, of adhesive to be used to adhere the backing layer to the panel layer.

Preferably, at least one profiled outer surface of at least one second roller comprises at least one profiled surface section and at least one unprofiled surface section. In this manner, for example, the edge(s) of the panel and/or a peripheral zone of the panel to be formed can remain untextured, and hence robust, while a centre portion of the second major surface of the panel layer can be provided with a texture. It is imaginable that this centre portion is partially profiled (textured) and partially unprofiled (untextured). The unprofiled part(s) of the centre portion of the panel layer typically contribute(s) to a stable positioning of the panel onto a subfloor. Typically, in case a plurality of unprofiled sections is applied to the second major surface, the panel layer thickness at the location of these unprofiled sections is preferably uniform. This uniform panel layer thickness normally exceeds the panel layer thickness at the location of the profiled section(s).

Preferably, the circumference of at least one profiled second roller is substantially equal to n times the length of a panel to be produced, wherein n≥1. This dimensioning allows to provide the second major surface of the panel layer with an impressed profile, while keeping at least two opposite edges of the panel to be formed free of any impressed profile. Preferably, the circumference of said second roller is at least 100 cm. Preferably, the width of at least one profiled second roller is substantially equal to n times the width of a panel to be produced, wherein n≥1, preferably wherein n≥2. Preferably, the width of said second roller is at least 60 cm.

For sake of completeness, the panel eventually formed based upon at least one calendered panel layer by using the system or method according to the invention, can have various shapes, such as a rounded shape and a polygonal shape (e.g. triangle, rectangle, square, pentagon, hexagon, heptagon or octagon). Preferably, The panel, and consequently the calendered panel layer, is provided in the shape of a square or a rectangle. However, the panels and/or the calendered panel layer can also have and/or be provided with a three dimensional shape, such as a corner-type shape which can usefully be employed as a panel connection between surfaces which are perpendicular to each other for use in, for example, wall and ceiling coverings with a printed design and an embossed surface, and even stairs. In one preferred embodiment, the panel can be formed as a rectangle with two pairs of opposing sides wherein the pairs of sides can be the same or different in length relative to each other. In one example, the panel is rectangular. The rectangular panel can have opposite shorter sides having a width, for example, of from 10 cm to 50 cm, preferably from 10 cm to 30 cm or other widths, and opposite langer sides having a length, for example, of from 50 cm to 300 cm, preferably from 80 cm to 250 cm or other lengths. In one example, the panel also may be square shaped, and have four sides of equal length. In some examples, the panels have square shapes with a side length of from 20 cm to 100 cm, preferably from 25 cm to 80 cm, more preferably from 30 cm to 60 cm, or other side lengths.

Preferably, the sheet-like panel layer has a width which equals or (slightly) exceeds n times the width of the panels to be eventually formed out of said panel layer, wherein n≥1. This will minimize material waste during the production, in particular cutting, of the panels.

In a preferred embodiment, at least one second roller, optionally each second roller, has a completely unprofiled outer surface to smoothen the second major surface of the panel layer. This makes it possible to select and use at least one second roller without a profiled outer surface during the calendering process, which will commonly result in a flat (smooth/planar) second major surface of the panel layer.

It is imaginable that at least two second axially rotatable rollers are mounted by different second mounting structures, such as two frames and/or two arms, respectively. This allows, for example, the second rollers to be moved independently from each other. It is commonly preferred that at least two second axially rotatable rollers are mounted by the same second mounting structure. This will allow to use to a single second mounting structure, which is favourable from an economic and practical point of view.

Preferably, at least one second mounting structure is configured to displace at least one second roller between (i) an aligned position with respect to said first roller, such that said roller nip is enclosed by said aligned rollers, and (ii) an idle position wherein said second roller does not contribute to the calendering of the panel layer. In this idle position, the second roller may be subjected to maintenance if needed, without disturbing the calendering process. To this end, the second mounting structure may be partially or entirely displaceable with respect to at least a part of the first mounting structure (or vice versa). Preferably, said at least one second mounting structure is configured to displace at least one second roller along a linear or curvilinear path. Here it is for example imaginable that at least a part of the second mounting structure is configured to displace the second rollers along a curved path to subject the second rollers, for example, to a rocking motion during displacement, and/or to displace the second rollers along a linear path to linearly move (translate) the second mounting structure at least partially. The second mounting structure may comprise one or more wheels, to allow the second mounting structure, or a part thereof, to roll over a subfloor, such as a flat floor or rails.

Additionally or alternatively, it is preferred that at least one second mounting structure is configured to displace at least one second roller along a circular path. This circular path may cover e.g. an entire circle or a circle segment, an oval or an oval segment, or an ellipse or an ellipse segment. Preferably, at least one second mounting structure comprises an axially rotatable carousel frame mounting a plurality of axially rotatable second rollers. By means of the carousel frame, a selected second roller can be rotated towards the active position, wherein the selected second roller is aligned with respect to the first roller for calendering purposes. The carousel is preferably rotatable around an axis which is substantially parallel to the rotation axis of the second rollers mounted by said carousel. As the second rollers are preferably axially rotatable around a horizontal axis for practical reasons, the carousel is preferably also rotatable around a horizontal axis. Preferably, at least a part of the carousel frame is positioned underneath or above the first roller, such that an uppermost second roller mounted by said carousel and said first roller define the roller nip. Preferably, the carousel frame comprises opposite rotatable discs, wherein the second rollers are positioned in between said discs and mounted by said discs. In fact, the discs may form side walls of the carousel or carousel frame. The discs are preferably mutually connected and mutually fixed by at least one connecting rod. Such a fixation will commonly improve the robustness of the carousel frame. One or both discs may be used for mounting one or more second electromotors for driving (axially rotating) one or more second rollers, and/or for mounting other components. One or both discs may have a toothed circumference, which allows the disc(s) to act as gear wheel which is configured to co-act, directly or indirectly, with a carousel electromotor driven other gear wheel for (axially) rotating the carousel frame. Preferably, each disc is covered by a stationary plate, which may be a circular plate, in this latter case also referred to as stationary disc. The stationary plate(s) may (also or alternatively) be used for mounting one or more second electromotors for driving (axially rotating) one or more second rollers, and/or for mounting other components, such as an electromotor for rotating the carousel frame. Optionally, the carousel frame as such may be displaceable in its entirety with respect to the first mounting structure to remove the carousel frame, and hence the second rollers mounted by the carousel frame, from the first roller. This, for example, facilitates maintenance of the carousel frame and/or of the second rollers.

The second rollers are preferably positioned below the first roller. In case a carousel frame is used for mounting the second rollers, preferably at least a part of the carousel frame, and more preferably the entire carousel frame is positioned underneath the first roller. This positioning lowers the centre of gravity of the calendering device, which renders the calendering device and therefore the system as such more stable, which is favourable from a production and safety point of view. Moreover, this relatively low positioning of the second rollers makes it easier to unmount and/or replace the second rollers, which is advantageous from a practical and safety point of view.

Preferably, the diameters of the second rollers are substantially identical. In this manner, an upper side (highest point) of the second roller used can be positioned at a predefined and constant level, which is commonly in favour of the securing a constant angle between the sheet-like panel layer (to be) led through the roller nip and the second roller. Preferably, the sheet-like panel layer is led according to the linear, horizontal path through said roller nip to prevent tearing or breaking of the—often still viscous—sheet-like panel layer. By applying identical diameters of the second rollers, this levelled feeding can be secured, in particular in case the second roller(s) is/are configured to support the sheet-like panel layer. In this embodiment, the first roller is typically located (directly) above the selected second roller. The first roller may be displaced in vertical direction, for example by using an electromotor, to adjust a height position of the first roller, and hence the height of the roller nip. This allows adjustment of the thickness of the sheet-like panel layer.

Preferably, each second roller is connected to at least one second electromotor for axially rotating said second roller, and/or at least one second roller co-acts and/or is configured to co-act with at least one second electromotor for axially rotating said second roller. More preferably, each second roller is connected to its own at least one second electromotor for axially rotating said second roller. Having each second roller connected to its own electromotor saves time to bring a selected second roller in an operational state, as this prevents that the selected second roller has to be firstly connected to at least one electromotor before becoming operational. This latter is not only time-consuming, but also requires specific skills of the operator, and moreover reduces the lifetime of the components used as well as requires more maintenance of the components used as these components are coupled and uncoupled from upon selection of another second roller. By providing each second roller with its own electromotor, these drawbacks could be prevented. Alternatively, two or more second rollers could be (permanently) connected to the same electromotor, although this option could be less preferred from an economical point of view in case this shared electromotor would be configured to simultaneously axially rotate said plurality of second rollers.

Preferably, at least the second roller positioned in the active position (facing the first roller) is a driven second roller. The other second roller(s) positioned in the idle position may be undriven second roller(s). This allows the application of a single second electromotor to (only) the drive the second roller which is in the active position. Preferably, the driven second roller faces a driven first roller. The first roller is normally driven by its own electromotor. During operation, the roller speeds of the first roller and the (active) second roller are preferably aligned. This allows that during operation the first roller and the (active) second roller can exert substantially identical pulling forces onto the sheet-like panel layer to pull said panel layer through the roller nip.

In case a carousel frame with discs is applied as at least a part of the second mounting structure, as described above, it is imaginable that at least one disc comprises at least one through-hole to allow said second electromotor to co-act with at least second roller via said through-hole. The through-hole extends preferably parallel and may coincide with a longitudinal axis of the second roller to be driven.

Preferably, the calendering device comprises a plurality of first axially rotatable rollers, mounted by at least one first mounting structure, wherein the at least one mounting structure is configured to align a selective first roller with a selective second roller, such that said roller nip is enclosed by said aligned rollers, wherein at least one first roller preferably has a profiled outer surface to impress a corresponding pattern into the first major surface of the panel layer. The first rollers may have the same properties and/or mounting structure, such as a carousel frame, as the second rollers may have, as described above and below. By applying a plurality of first rollers, the degree of freedom to select the first and second rollers to be used during the calendering process can further be increased, wherein a chosen combination of rollers can be brought in place quickly and efficiently. A profiled first roller may be used to apply a (counter)profile, such as a texture and/or pattern, in the first major surface of the panel layer. Here, at least one profiled outer surface of at least one first roller may, for example, comprise at least one matrix and/or honeycomb and/or waffle based profile and/or may comprise one or more protruding knobs or beads, preferably arranged in a pattern, and preferably having a polygonal cross-section. This may further reduce the weight of the panel layer and may further improve the sound dampening properties. Preferably, at least one first roller co-acts and/or is configured to co-act with at least one first electromotor for axially rotating said first roller. Preferably, each first roller and/or each second roller is axially rotatable around a horizontal axis. Preferably, each first roller and/or each second roller substantially (circular) cylindrical. However, other shapes, like a frustoconical shape (which would lead to a tapered roller), would also be imaginable.

Preferably, as indicated above, the calendering device comprises at least one electromotor to change the mutual distance between the first roller and at least one second roller. In this manner, the nip height can be adjusted in line with a (desired) thickness of the panel layer to be calendered and/or the first roller(s) and second roller(s) can be moved away from each other for, for example, maintenance purposes. The roller nip range preferably varies from 0 to 10 mm, preferably from 0 to 6 mm. The rotation speed of the first roller and second roller during calendering preferably varies from 0 to 100 meter per minute, preferably from 50 tot 90 meter per minute. At least one, preferably each, first roller and/or second roller is preferably at least partially made of metal, preferably steel, in particular stainless steel. The profiled outer surface of a roller preferably makes integral part of the roller. However, it is also imaginable that at least one first roller and/or at least one second roller is provided with a coating and/or sleeve bearing said profiled outer surface. The coating and/or sleeve may be permanently attached to the roller or may be removable from the roller.

In a preferred embodiment, at least one first roller and/or at least one second roller comprises at least one heating element for heating the outer surface of said roller. By heating the panel layer, deformation of the panel layer during the calendering process is facilitated. Typically, a thermoplastic based panel layer is produced by means of extrusion, after which the extruded panel layer—still in softened state (due to an elevated temperature)—is led into the calendering device. Since the panel layer material is still soft(ened), the panel layer can be deformed relatively easily, without having the risk to damage, such as breaking or cracking, the panel layer. Moreover, impressing the grooves into the panel layer when the panel layer is still in a softened state prevents the tools used for impressing the panel layer from excessive wear. Moreover, in this manner no additional tooling (heating stations and/or rollers) downstream the calendering device are needed to texture at least one major surface of the panel layer. An additional advantage of impressing is that no material (often in the form of dust) will have to be removed afterwards for realizing the textured major surface(s) of the panel layer, which is favourable from a practical, safety, and health point of view.

The panel layer used in the system and method according to the invention preferably comprises at least one thermoplastic polymer, such as PET, PP, (T)PU, PE, or PVC, or mixtures thereof. The polymer may be a virgin polymer, a recycled polymer, or mixtures thereof. Preferably, the panel layers also comprises one or more additives, such as at least one filler, preferably a filler selected from the group consisting of: talc, chalk, wood, calcium carbonate, titanium dioxide, calcined clay, porcelain, glass, carbon particles, silicon particular, a(nother) mineral filler, a(nother) natural filler, a(nother) (auxiliary) polymer, such as an elastomer and/or latex. It is also imaginable that rubber and/or elastomeric parts (particles) are dispersed within the thermoplastic matrix to improve the flexibility and/or impact resistance at least to some extent. The panel layer, when cooled down, may (thus) be rigid, semi-flexible, or flexible, and so can be the panel as such. The filler may be formed by fibres, such as glass fibers or synthetic or genuine leather fibers, and/or may be formed by dust-like particles. Here, the expression “dust” is understood as small dust-like particles (powder), like bamboo dust, wood dust, cork dust, or non-wood dust, like mineral dust, stone powder, in particular cement, and combinations thereof. The average particle size of the dust is preferably between 14 and 20 micron, more preferably between 16 and 18 micron. The primary role of this kind of filler is to provide the core, and the panel as such, with sufficient hardness and/or to decrease the cost price of the core, and hence of the panel. Moreover, this kind of filler will typically also improve the impact strength of the panel layer and of the panel as such. Preferably, the filler content in the composite material of the panel layer is between 30 and 75% by weight of the composite material of the panel layer, more preferably between 60 and 75% by weight of the composite material of the panel layer. Preferably, the polymer content in the composite material of the core is between 25 and 70% by weight of the composite material of the panel layer, more preferably between 25 and 40% by weight of the composite material of the panel layer. The polymer can either be foamed or unfoamed. Preferably, the composite of the panel layer comprises at least one filler and/or additive selected from the group consisting of: a salt, a stearate salt, calcium stearate, and zinc stearate. Stearates have the function of a stabilizer, and lead to a more beneficial processing temperature, and counteract decomposition of components of the composite during processing and after processing, which therefore provide long-term stability. Instead of or in addition to a stearate, for example calcium zinc may also be used as stabilizer. The weight content of the stabilizer(s) in the composite will preferably be between 1 and 5%, and more preferably between 1.5 and 4%. The composite of the panel layer preferably comprises at least one impact modifier comprising at least one alkyl methacrylate, wherein said alkyl methacrylate is preferably chosen from the group consisting of: methyl methacrylate, ethyl methacrylate, propyl methacrylate, isopropyl methacrylate, t-butyl methacrylate and isobutyl methacrylate. The impact modifier typically improves the product performance, in particular the impact resistance. Moreover, the impact modifier typically toughens the panel layer and can therefore also be seen as toughening agent, which further reduces the risk of breakage. Often, the modifier also facilitates the production process, for example, as already addressed above, in order to control the formation of the foam with a relatively consistent (constant) foam structure. The weight content of the impact modifier in the composite will preferably be between 1 and 9%, and more preferably between 1 and 6%. At least one plastic material used in the panel layer is preferably free of any (toxic) plasticizer in order to increase the desired rigidity of the panel layer, which is, moreover, also favourable from an environmental point of view.

It is imaginable that the calendering device is configured to simultaneously calender a plurality of different panels layers, which are preferably laminated during calendering and/or in a subsequent lamination station in the system. The different panel layers may be produced by means of co-extrusion, preferably directly upstream of the calendering device. This allows, for example, that the panel is provided with at least two zones (layers) of different composition. The different compositions in different zones may result in mutually different features, such as, for example, in respect to elasticity, colour, adherence, smoothness of the surface, processability and the like. Different compositions in different zones may, for example, be based upon different ratios between polymeric material, in particular thermoplastic material (like PVC and/or TPU and/or PET and/or PP), and non-polymeric material, in particular filler, more in particular mineral filler (like chalk). For example, to this end, it is imaginable that at least one core layer is relatively stiff or rigid, and another core layer, preferably positioned underneath the first mentioned core layer during normal use, is relatively flexible or soft. Preferably, at least one first panel layer has a softer composition and/or a lower Vicat softening point than at least one second panel layer. This makes it relatively easy to provide impressions, such as grooves, slots, or alternative cavities, in the first panel layer (in viscous state), while the (harder) second panel layer can be used to provide the panel as such more hardness and/or rigidity. Typically, the Vicat softening point (Vicat softening temperature) is measured according to standards D 1525 and/or ISO 306. It is imaginable that at least two panel layers are provided with at least one impressed pattern. It is imaginable and often preferred that a side of at least one panel layer, which is provided with at least one impressed pattern, is facing away from an adjacent panel layer. Alternatively or additionally, it is also possible that a side of at least one panel layer, which is provided with at least one impressed pattern, is facing towards an adjacent panel layer. This latter embodiment will enclosing the impressed pattern(s) by said facing panel layers. This will typically lead to (air) pockets incorporated within the panel as such. The impressed pattern(s) of different panel layers may be identical or may be distinctive. At least one of these impressed pattern(s) may be filled, e.g. by a sound dampening material, such as felt, flax, wool, a foamed material, etcetera. It is imaginable that at least one panel layer is free of any impressed pattern. At least one panel layer may be a reinforcement layer, such as a glass fiber layer and/or a graphene (or derivative thereof) based layer. It is imaginable that at least one panel layer is at least partially, preferably substantially entirely, composed of at least one elastic material and/or soft material and/or compressible material. Such a panel layer typically improves the user comfort of the panel as such and improves the acoustic properties of the panel. Preferably, such a (comfort) layer comprises a material selected from the group consisting of: a natural rubber, a synthetic rubber, an alternative elastomer, a polyolefin, a foamed polymer, and at least one natural material, preferably a natural material chosen from the group consisting of: cork, bamboo, hemp, linen, flax, jute, sisal, coconut fibers, banana fibers, cotton, felt, and/or leather. The foamed polymer may constitute a closed-cell foam or an open cell foam. Preferably, said foamed polymer is a(n elastically) compressible foamed polymer, such as PVC foam, PU foam, preferably thermoplastic PU (TPU) foam, EVA foam, cross-linked polyethylene foam (XPE), irradiation cross-linked polyethylene foam (IXPE), and expanded polyethylene foam (EPE). XPE foam and IXPE are both closed-cell PE foams, typically with even and fine internal cells are even and fine, wherein the water absorption rate is extremely low, while the sound insulation, heat insulation, shock absorption performance, and mechanical properties are relatively good. It is imaginable that this (comfort) panel layer is composed of a plurality of layers, such as e.g. a laminate of at least one polymer (comprising) layer and at least one layer composed of natural material, and/or a laminate of a plurality of polymer (comprising) layers. Non-limitative examples of such laminated core layers are: (i) an EVA layer (ethylene-vinyl acetate) layer with a preferred thickness of between 0.5 and 1.8 mm, laminated with a PE film, with a preferred thickness of between 0.5 and 1.8 mm, and (ii) an expanded polyethylene layer (EPE layer) with a preferred thickness of between 0.5 and 2.5 mm, laminated with a PE film, with a preferred thickness of between 25 micron and 1.5 mm. This comfort panel layer and/or any other panel layer may be given a desired colour by adding at least one pigment to the core layer. Preferably, at least one colour of at least one panel layer is chosen from the group consisting of: white, yellow, blue, red, green, brown, azure, ivory, teal, silver, purple, navy blue, pea green, orange, maroon, aquamarine, coral, fuchsia, wheat, lime, crimson, khaki, pink, magenta, olden, plum, olive, cyan, or a plurality of colours thereof. This colour is typically visible as seen from a side view of the panel. The colour preferably provides an indication of at least one layer related characteristic of the (comfort) panel layer, such as e.g. the layer thickness, the density, at least a part of the material composition, the recyclability, the compostability, the temperature resistance, the moisture resistance, the anti-bacterial properties, the compressibility, the swell rating, the compressive strength, and/or the acoustic dampening (sound absorption). The (comfort) panel layer may be provided with a impressed pattern, such as e.g. a waffle pattern and/or a matrix pattern, although alternative patterns are also imaginable. This may improve the comfort properties of the panel, the acoustic properties of the panel, and will lead to an increased contact surface area between the (comfort) panel layer and an adjacent layer, which typically will intensify the bonding of said layers. Optionally, at a rear side of the panel at least one backing layer may be applied, normally after the calendering process, which typically (further) improves the comfort properties and acoustic properties of the panels. Preferred materials for the backing layer are a natural rubber, a synthetic rubber, an alternative elastomer, a polyolefin, a foamed polymer, such as EPE, XPE, and IXPE, and at least one natural material, preferably a natural material chosen from the group consisting of: cork, bamboo, hemp, linen, flax, jute, sisal, coconut fibers, banana fibers, cotton, felt, and/or leather. The one or more backing layers may be closed and may act as sound dampening membrane. In case more backing layers are applied, these backing layer are preferably laminated on top of each other. It is also imaginable that the backing layer(s) is/are provided with through-holes connecting to the impressed pattern(s), if applied, at a rear side of the core.

In case of simultaneously calendering a plurality of panel layers, each of the panel layers may be calendered by a different set of rollers. It is however imaginable that at least one roller is a shared roller being configured to simultaneously co-act with each panel layer during the calendering process.

Preferably, the calendering device comprises at least one additional roller to calender the panel layer, wherein said at least one additional roller and an adjacent roller mutually define a further roller nip causes calendering and/or guiding and/or laminating said panel layer. In this manner, the panel layer can be led, for example, according to a zigzag path, to a desired location or position and/or the panel layer can be adhered to at least one other panel layer, for example by means of fusion. In this latter case, said additional roller and/or said adjacent roller may be a heatable roller.

Preferably, the system, in particular the calendering device, of the invention comprises at least one further roller, preferably a heated roller, positioned downstream of the first roller, to guide at least one additional material layer, such as a decorative layer and/or at least one wear layer, towards said sheet-like thermoplastic based panel layer to laminate said at least one additional material layer onto said sheet-like thermoplastic based panel layer, preferably by means of fusing. In case the system, in particular the calendering device, according to the invention is configured to laminate layers, preferably downstream of the first roller (and second roller), the system, in particular the calendering device, preferably comprises at least one additional mounting structure for at least one supply roll of at least one additional material layer, such as a decorative layer and/or at least one wear layer, to be laminated onto said sheet-like thermoplastic based panel layer, preferably by means of fusing, wherein said additional mounting structure and/or said at least one supply roll is preferably positioned downstream of the first roller. The supply roll may be supported by a (permanent) roller mounted to said additional mounting structure and/or may be directly mounted to the additional mounting structure. Preferably, said one or more supply rolls are positioned above the sheet-like panel layer, and hence preferably at a level above the lowest roller of the first roller and (active) second roller. It is imaginable that a plurality of additional layers is, typically successively, laminated onto to the sheet-like panel layer. Examples of such additional layers are a decorative layer, which decorative layer is typically formed by a paper and/or (thermos)plastic film bearing a decorative design, such as a wood nerve pattern; and one or more transparent and/or translucent, preferably thermoplastic, wear layers which are typically used to cover the decorative layer to protect the decorative design of said decorative layer. In this latter case, the decorative layer is applied firstly onto the sheet-like panel layer and successively one or more wear layers are applied onto the decorative layer. Mutually adhering the panel layers is preferably realized by means of heat pressing (hot pressing) which may cause fusion of adjacent layers. Preferably, the system comprises at least one additional panel layer, and wherein the calendering device is configured to laminate said sheet-like thermoplastic based panel layer with said additional panel layer, preferably by means of fusing. It is also imaginable, as indicated above, that the system comprises a laminating station downstream or upstream the calendering device. In order to realize lamination, the layers to be laminated may be heated prior to passing the layers through the roller nip in between a pair of pressure rollers. The two panel layers are then pressed together at the roller nip of the pair of pressure rollers. Additionally or alternatively, the first roller and/or second roller is/are heated, after/during which that panel layers to be laminated are fed into the roller nip of the heated roller(s) and heated precisely at the point of pressurization.

At least one of the panel layers to be laminated in the system, preferably in the calendering device, according to the invention, may be a core layer of the panel to be eventually formed or a layer of a decorative top structure of the panel to be eventually formed.

As already indicated above, the system preferably comprises at least one extruder positioned upstream with respect to said calendering device, wherein said extruder is configured to produce said sheet-like thermoplastic based panel layer. Preferably, a die (discharge mouth) of the extruder and the roller nip are positioned at substantially the same level. This allows the sheet-like panel layer discharged from the die of the extruder to be fed to the roller nip in a substantially horizontal orientation, which reduces the risk of tearing and breakage of the still viscous (and hence vulnerable) sheet-like panel layer. It may, however, be preferred that the system is configured to adjust the mutual distance between (the die of) the extruder and the roller nip. Dependent on the distance adjustment, this allows the sheet-like panel layer to cool down more or less intensively, which allows to bring the viscosity and stability of the sheet-like panel layer to a desired level for calendering and optionally for (subsequent) lamination purposes.

Preferably, the system comprises at least one printing station positioned downstream with respect to said calendering device, wherein said printing station device is to provide said sheet-like thermoplastic based panel layer with at least one decorative layer and/or protective print layer, wherein the printing station preferably comprises at least one curing station for curing ink printed, directly or indirectly, onto said sheet-like panel layer. At least one printing station may be configured to realize an embossing structure (textured surface) which is visible and feelable on top surface of the panel. Preferably, at least a part of the textured surface of the top structure is aligned in register with at least a part of at least one decor image formed by the decorative print layer, in particular at least one pattern defined by at least one decor image formed by the decorative print layer. By applying an alignment in register, also referred to as embossing in register, a very realistic and/or artistic design and appearance of the panel can be realized. In this manner, for example, a realistic wood nerve pattern can be realized, wherein the decorated printed wood nerves (2D) are in register (in line) with the embossed printed wood nerves (3D). The same effect can, for example, be realized with a stone like design, an animal skin design, etcetera. Also, in case one or more artificial, decorative grout lines are printed, the textured surface may comprise one or more recessed channels directly above said decorative grout lines to realize a realistic appearance of the panel which is practically equal to the surface relief obtained when using real tiles and grouts.

The visual decorative print layer may be composed solely of a decorative ink layer, but is also imaginable that the visual print layer comprises a substrate layer, such as a polymer film or paper film, onto which a decorative ink layer is printed or otherwise applied. Said visual print layer may be attached directly to the core, e.g. by fusing the visual print layer onto the core or by gluing the visual print layer to the core, wherein use can be made e.g. of a polyurethane adhesive. Optionally, an upper surface of the calendered panel layer (or any other layer adhered or fused thereto) is covered by at least one primer layer before attaching the visual print layer to the panel layer, wherein the visual print layer will actually be attached to the (upper) primer layer applied to the calendered panel layer (or any other panel layer). As mentioned above, the decorative top structure, which may be a single layer or a plurality of layer, in particular a laminate of layers, can be partially or entirely by realized by digital printing. Optionally, the substance, in particular the ink, to realize at least a part of the at least one wear layer and/or top coating covering said decorative layer can be free of photoinitiators. It is imaginable that the decorative top structure comprises a decorative visual print layer and a single—only one—transparent or translucent wear layer on top of said visual print layer without applying a separate top coating layer. At least one wear layer, and preferably each wear layer in case a plurality of wear would be applied, is preferably made of transparent or translucent polyurethane or, alternatively, polyvinylchloride, polypropylene, or any another suitable transparent or translucent polymer. Typically, at least one layer of the decorative top structure is cured by using UV curing and/or electron beam (EB) curing and/or by heat. At least one curing device to realize curing and/or hardening of the ink may make part of the printing station of the system according to the invention.

Preferably, the system comprises at least one cutting device positioned downstream with respect to said calendering device, wherein said cutting device is configured to cut said sheet-like thermoplastic based panel layer into a plurality of segments having a length and width which substantially or entirely corresponds to a length and width of the panels to be produced. It is imaginable that the system comprises at least one profiling device positioned downstream with respect to said calendering device, and preferably downstream of said cutting device, wherein said profiling device is configured to profile at least two edges of said sheet-like thermoplastic based panel layer to allow the panels to be formed to interconnect. A first edge and an opposite second edge may for example be provided with a first coupling profile and a complementary second coupling profile, respectively. A third edge and an opposite fourth edge may for example be provided with a third coupling profile and a complementary fourth coupling profile, respectively. In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank.

The invention also relates to a calendering device for use in a system according to the invention. The invention further relates to a carousel frame mounting or for mounting a plurality of second rollers, wherein at least one second roller is preferably provided with a profiled outer surface, to be used in the calender device according to the invention.

The invention moreover relates to a method of producing panels, in particular decorative panels, such as a floor panel, ceiling panel or wall panel, at least partially, preferably by using the system according to any of the preceding claims, said method the steps of:
A) selecting a second axially rotatable roller out of a plurality of second axially rotatable rollers for the purpose of calendering a panel layer, wherein said second axially rotatable roller is mounted by a second mounting structure,
B) aligning a first axially rotatable roller mounted by a first mounting structure with the selected second axially rotatable roller by, if needed, mutually displacing said first mounting structure and said second mounting structure, such that a roller nip is enclosed by said aligned rollers,
C) guiding a, preferably extruded, sheet-like thermoplastic based panel layer through said roller nip, and
D) forcing at least one of said aligned rollers to axially rotate resulting in calendering of the panel layer, wherein preferably during this step a pattern is impressed into a major surface of the panel layer by a profiled outer surface of the selected second roller.

Further embodiments of the method have already been described above and will be described below in an extensive manner. Preferably, during step C) the panel layer is in a viscous, deformable state, and wherein the panel layer is preferably at elevated temperature.

The invention also relates to a panel layer, as well as to a panel comprising a panel layer having at least one impressed major surface by applying the method according to the invention and/or by using the system according to the invention.

Embodiments of the invention are further described in the non-limitative set of clauses presented below.

1. System for producing panels, in particular decorative panels, such as a floor panel, ceiling panel or wall panel, at least partially, said system comprising:
at least one calendering device for calendering a sheet-like thermoplastic based panel layer of at least one panel to be produced, said panel layer having first and second opposed major surfaces, wherein said calendering device comprises:
   at least one first axially rotatable roller mounted by a first mounting structure,
   a plurality of second axially rotatable rollers, mounted by at least one second mounting structure,
   wherein at least a part of said first mounting structure and at least a part of said at least one second mounting structure are mutually displaceable to align a selective second roller with said first roller, such that a roller nip is enclosed by said aligned rollers, whereby passage of said panel layer through said roller nip causes calendering of said panel layer, and
   wherein at least one second roller has a profiled outer surface to impress a corresponding pattern into the second major surface of the panel layer.

2. System according to clause 1, wherein at least two second rollers have a profiled outer surface, wherein the profiled outer surfaces of said second rollers mutually differ.

3. System according to any of the preceding clauses, wherein at least one profiled outer surface of at least one second roller comprises at least one impression patterns.

4. System according to clause 3, wherein at least one profiled outer surface of at least one second roller comprises a plurality of impression patterns.

5. System according to clause 3 or 4, wherein the length and/or width of each panel to be produced based upon said panel layer exceeds the length and/or width of each impression pattern.

6. System according to any of the preceding clauses, wherein at least one profiled outer surface of at least one second roller comprises at least one set of plurality of parallel recessed and/or protruding tracks.

7. System according to any of the preceding clauses, wherein at least one profiled outer surface of at least one second roller comprises at least one matrix and/or honeycomb based profile.

8. System according to any of the preceding clauses, wherein at least one profiled outer surface of at least one second roller comprises at least one profiled surface section and at least one unprofiled surface section.

9. System according to any of the preceding clauses, wherein the circumference of at least one profiled second roller is substantially equal to n times the length of a panel to be produced, wherein n≥1.

10. System according to any of the preceding clauses, wherein at least one second roller has a completely unprofiled outer surface to smoothen the second major surface of the panel layer.

11. System according to any of the preceding clauses, wherein at least two second axially rotatable rollers are mounted by different second mounting structures, respectively.

12. System according to any of the preceding clauses, wherein at least two second axially rotatable rollers are mounted by the same second mounting structure.

13. System according to any of the preceding clauses, wherein at least one second mounting structure is configured to displace at least one second roller between (i) an aligned position with respect to said first roller, such that said roller nip is enclosed by said aligned rollers, and (ii) an idle position wherein said second roller does not contribute to the calendering of the panel layer.

14. System according to clause 13, wherein said at least one second mounting structure is configured to displace at least one second roller along a linear or curvilinear path.

15. System according to clause 13 or 14, wherein said at least one second mounting structure is configured to displace at least one second roller along a circular path.

16. System according to any of the preceding clauses, wherein at least one second mounting structure comprises an axially rotatable carousel frame mounting a plurality of axially rotatable second rollers.

17. System according to clause 16, wherein the carousel frame is positioned underneath the first roller, such that an uppermost second roller mounted by said carousel and said first roller define the roller nip.

18. System according to clause 16 or 17, wherein the carousel frame comprises opposite rotatable discs, wherein the second rollers are positioned in between said discs and mounted by said discs.

19. System according to clause 18, wherein the discs are mutually connected and mutually fixed by at least one connecting rod.

20. System according to clause 18 or 19, wherein at least one disc is configured as gear wheel which co-acts with a carousel electromotor driven other gear wheel for rotating the carousel frame.

21. System according to any of the preceding clauses, wherein at least one second roller co-acts and/or is configured to co-act with at least one second electromotor for axially rotating said second roller.

22. System according to clause 20 and 21, wherein at least one disc comprises at least one through-hole to allow said second electromotor to co-act with at least second roller via said through-hole.

23. System according to any of the preceding clauses, wherein the calendering device comprises a plurality of first axially rotatable rollers, mounted by at least one first mounting structure, wherein the at least one mounting structure is configured to align a selective first roller with a selective second roller, such that said roller nip is enclosed by said aligned rollers, wherein at least one first roller preferably has a profiled outer surface to impress a corresponding pattern into the first major surface of the panel layer.

24. System according to any of the preceding clauses, wherein at least one first roller co-acts and/or is configured to co-act with at least one first electromotor for axially rotating said first roller.

25. System according to any of the preceding clauses, wherein each roller is axially rotatable around a horizontal axis.

26. System according to any of the preceding clauses, wherein the calendering device is configured to change the mutual distance between the first roller and at least one second roller, and/or wherein the calendering device comprises at least one electromotor to change the mutual distance between the first roller and at least one second roller.

27. System according to any of the preceding clauses, wherein the calendering device is configured to change the height position of the first roller and/or of the first mounting structure to allow adjustment of the height of the roller nip between the first roller and at least one second roller.

28. System according to any of the preceding clauses, wherein the second rollers are positioned below the first roller.

29. System according to any of the preceding clauses, wherein the diameters of the second rollers are substantially identical.

30. System according to any of the preceding clauses, wherein the first roller and the facing second rollers are actively driven rollers.

31. System according to any of the preceding clauses, wherein at least one first roller and/or at least one second roller comprises at least one heating element for heating the outer surface of said roller.

32. System according to any of the preceding clauses, wherein the calendering device comprises at least one additional roller to calender the panel layer, wherein said at least one additional roller and an adjacent roller mutually define a further roller nip causes calendering and/or guiding and/or laminating said panel layer.

33. System according to any of the preceding clauses, wherein the system, in particular the calendering device, comprises at least one further roller, preferably a heated roller, positioned downstream of the first roller, to guide at least one additional material layer, such as a decorative layer and/or at least one wear layer, towards said sheet-like thermoplastic based panel layer to laminate said at least one additional material layer onto said sheet-like thermoplastic based panel layer, preferably by means of fusing.

34. System according to any of the preceding clauses, wherein the system, in particular the calendering device, comprises at least one additional mounting structure for at least one supply roll of at least one additional material layer, such as a decorative layer and/or at least one wear layer, to be laminated onto said sheet-like thermoplastic based panel layer, preferably by means of fusing, wherein said additional mounting structure and/or said at least one supply roll is preferably positioned downstream of the first roller.

35. System according to any of the preceding clauses, wherein the system comprises at least one additional panel layer, and wherein the calendering device is configured to laminate said sheet-like thermoplastic based panel layer with said additional panel layer, preferably by means of fusing.

36. System according to any of the preceding clauses, wherein the system comprises at least one extruder positioned upstream with respect to said calendering device, wherein said extruder is configured to produce said sheet-like thermoplastic based panel layer.

37. System according to any of the preceding clauses, wherein a die of the extruder and the roller nip are positioned at substantially the same level.

38. System according to any of the preceding clauses, wherein the system is configured to adjust the mutual distance between the extruder and the roller nip.

39. System according to any of the preceding clauses, wherein the system comprises at least one printing station positioned downstream with respect to said calendering device, wherein said printing station device is to provide said sheet-like thermoplastic based panel layer with at least one decorative and/or protective print layer, wherein the printing station preferably comprises at least one curing station for curing ink printed, directly or indirectly, onto said sheet-like panel layer.

40. System according to any of the preceding clauses, wherein the system comprises at least one cutting device positioned downstream with respect to said calendering device, wherein said cutting device is configured to cut said sheet-like thermoplastic based panel layer into a plurality of segments having a length and width which substantially corresponds to a length and width of the panels to be produced.

41. System according to any of the preceding clauses, wherein the system comprises at least one profiling device positioned downstream with respect to said calendering device, and preferably downstream of said cutting device, wherein said profiling device is configured to profile at least two edges of said sheet-like thermoplastic based panel layer to allow the panels to be formed to interconnect.

42. System according to any of the preceding clauses, wherein the profiled outer surface of at least one second roller is provided with a plurality of protrusions, wherein, preferably, at least 50% of said protrusions have a height of between 0.05 and 2 mm.

43. Calendering device for use in a system according to any of the preceding clauses.

44. Method of producing panels, in particular decorative panels, such as a floor panel, ceiling panel or wall panel, at least partially, by using the system according to any of the preceding clauses, said method the steps of:
A) selecting a second axially rotatable roller out of a plurality of second axially rotatable rollers for the purpose of calendering a panel layer, wherein said second axially rotatable roller is mounted by a second mounting structure,
B) aligning a first axially rotatable roller mounted by a first mounting structure with the selected second axially rotatable roller by, if needed, mutually displacing said first mounting structure and said second mounting structure, such that a roller nip is enclosed by said aligned rollers,
C) guiding a, preferably extruded, sheet-like thermoplastic based panel layer through said roller nip, and
D) forcing at least one of said aligned rollers to axially rotate resulting in calendering of the panel layer, wherein preferably during this step a pattern is impressed into a major surface of the panel layer by a profiled outer surface of the selected second roller.

45. Method according to clause 44, wherein during step C) the panel layer is in a viscous, deformable state, and wherein the panel layer is preferably at elevated temperature.

46. Panel comprising a panel layer having at least one impressed major surface by applying the method according to clause 44 or 45, and/or by using the system according to any of clauses 1-42.

### BRIEF DESCRIPTION OF THE DRAWINGS

The terms Fig., Figs., Figure, and Figures are used interchangeably in the specification to refer to the corresponding figures in the drawings.

The present invention will hereinafter be further elucidated based on the following non-limitative figures, wherein:

FIG. 1 shows a system for producing panels according to an embodiment of the present invention;

FIGS. 2a and 2b show two sides of an embodiment of a calendering device according to the invention;

FIG. 3 shows a perspective view of a part of the calendering device according to the invention;

FIG. 4 shows a second, different perspective view of a part of the calendering device according to the invention; and

FIG. 5 shows a schematic representation of a different embodiment.

### DESCRIPTION OF THE INVENTION

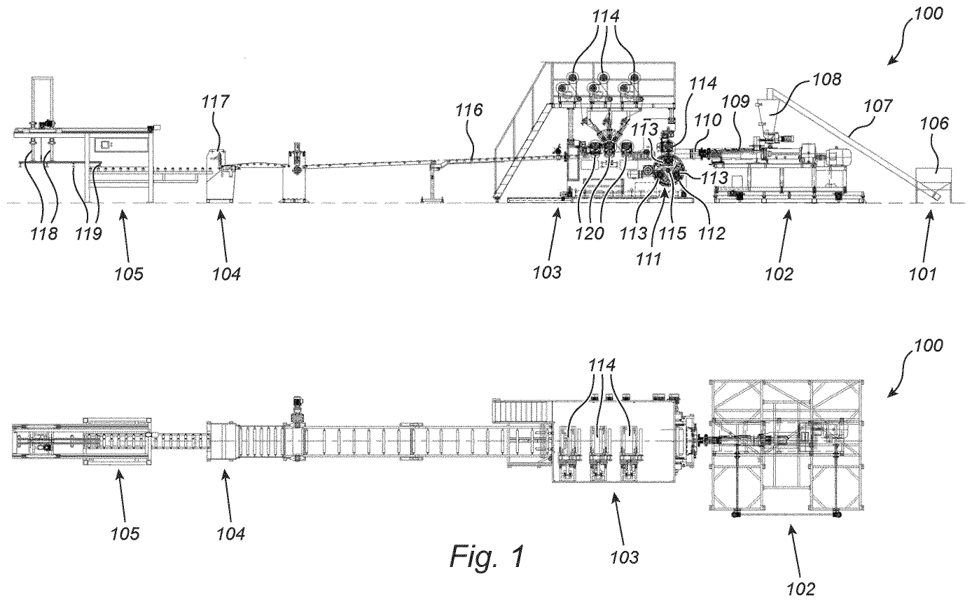

FIG. 1 shows a non-limitative embodiment of a system 100 for producing panels according to the present invention. The system 100 is in particular for producing decorative panels such as a floor panel, ceiling panel or wall panel, or at least a part of said panels.

The system 100 as shown in this embodiment comprises a number of stages 101, 102, 103, 104, 105. The first stage is a raw material stage 101. Here, a container or holder 106 may be provided which is configured to hold a volume of bulk material. Said bulk material may be of any type for production of the panels according to the invention. That is, the type of bulk material may depend on the specific panel requirements. Some panels may require the bulk product to be (thermoplastic)polymer, other appliances of the panels may require the product to be composed out of plant-based materials. It is conceivable that the raw material stage 101 comprises a number of containers 106, or a single container 106 comprising multiple, preferably distinct, volumes for holding a plurality of bulk materials. This may allow the system 100 to, preferably selectively based on a control unit, select the required bulk product based on the requirements for the core material of the panel to be fabricated. The bulk material, or a composition of bulk material that is selected, may be transported towards a melting or extruding stage 102. The bulk material may be transported e.g., by means of a screw conveyor, however, regular type belt conveyors may also be suitable. Yet, the invention is not limited to this aspect and various other manners may be applied to transport the bulk material to the extruding stage 102. For example, for future usage, drones may be applied in order to provide said bulk material to the extruding stage 102 (optionally without the use of a bulk material stage 101). The bulk material is deposited into a funnel 108 of the extruding stage 102. Although a funnel 108 is shown, it is conceivable that the bulk material is directly deposited into a heating barrel 109 of the extruding stage 102. However, such a funnel 108 may account for short interruptions in the bulk supply, whilst maintaining a continuous throughput. The extruding stage 102 is configured for producing a sheet-like panel layer, preferably composed out of the type of bulk material that is chosen. To this end, the bulk material is melted in a heating barrel 109, and subsequently forced through a die 110 to form said sheet. The type of die 110 used may for example be a T-die 110. Said T-die 110 receives the bulk material in an at least partially liquid form. In order to melt the bulk material, the heating barrel 109 may be heated towards a specific temperature, preferably above a glass transition temperature of the thermoplastic bulk material. The barrel 109 may be heated electrically or through other means, such as by means of residual heat from district heating or other systems from a factory floor. The amount of heat required may for example be situated between 1.0 and 10.0 kW, optionally comprising multiple heating stages. Multiple heating stages may for example alter material properties according to a specific need. In order to prevent the raw material from solidifying in the die 110 it is conceivable the die 110 is heated, preferably using between 5.0 and 15.0 kW, in particular 12 kW. However, the heating power may be different according to the specific type of bulk material that is used. Since the sheet-like material that is produced through the die 110 may be at least partially deformable, it is conceivable that the sheet-like panel layer is extruded onto a conveyor to support the sheet-like panel layer. Downstream of the extruding stage 102 a calendering stage 103 is arranged. The calendering system 111 according to the present invention is in particular beneficial. The calendering system 111 according to the invention allows for purpose selectively allocating a set of calendering rollers 114, 113. The sheet-like panel layer extruded from the aforementioned die 110 will pass through the set of selected rollers 113, 114. The distance between said rollers 113, 114 is called the nip and may be adjustable. It is in particular beneficial that the calendering system 111 comprises a plurality of rollers 113 from which one may be selected to form the pair of rollers 113, 114, that form an aligned pair with a predetermined nip. Although this embodiment shows a total of three purpose-selective rollers 113, it is conceivable that more, or less are provided. The top roller 114, which may also be referred to as a first rotatable roller, may be mounted to the calendering stage 103 by means of a first mounting structure, such as a frame. The purpose-selective rollers 113, which may also be referred to as second rotatable rollers 113, may be mounted to the calendering stage 103 through a second mounting structure 112. The mounting structure 112 in this non limitative embodiment is formed by a pair of circular discs, mutually separated by means of at least one rod. Between said discs the second rotatable rollers 113 are arranged, preferably each being rotatable around an axial axis of rotation. The second mounting structure 112 is configured to rotate around an axis of rotation 115. By rotating the second mounting structure 112, the specific second roller 113 with which the first roller 114 forms an aligned pair may be selected. Although this non-limitative embodiment depicts the calendering stage 103 with a second mounting structure 112 in the form of discs is displayed, alternatives are very well conceivable. For example, instead of allocating the second rollers 113 on a rotatable second mounting structure 112, it is possible to provide said second rollers 113 onto a translatable structure. For example, such as to linearly displace the second rollers 113 to form an aligned pair with the first roller 114. Yet alternatively it is conceivable that the second mounting structure 112 is at least partially formed by one or more movable arms, for example robotic arms, or pneumatic arms. It may be understood that different solutions are possible for establishing one aligned pair of rollers 113, 114. It is however preferred that the second mounting structure 112 allows for mounting a plurality of second rollers 113, for example during installation of the system 110, in order to prevent manual exchange of the second rollers 113 during operation of the system 100. Therefore, it is also preferred that different second rollers 113 comprise a differently profiled outer surface. The profiled surface causes to impress a corresponding pattern and/or profile into a surface of the sheet-like panel layer that passes through the nip of the aligned pair of rollers 113, 114. Since the second mounting structure 112 is provided with a plurality of second rollers 113 it is possible to eliminate the need to replace said second rollers 113 in case a different impressing profile is required, which may include a different impressing pattern and/or different impressing profile dimensions, a suitable second mounting structure 112 is selected and positioned such as to align a different pair of rollers 113, 114. Manual replacement of the rollers 113, 114 is a cumbersome job in particular since said rollers 113 may weigh hundreds of kilograms. Hence, all second rollers 113 according to the present invention are pre-installed through a second mounting structure 112. It is understood that the mounting structure 112 may be a single structure, or a dedicated mounting structure for each second roller 113 may be applied as long as it remains possible to pre-install said second rollers 113 and purpose-selectively replace said second rollers to form a new aligned pair of rollers 113, 114. Moving the second mounting structure 112 may be possible through a drive system, for example an electromotor. It is furthermore, optionally, possible to arrange the first roller 114 in a similar way as the second rollers 113, hence by means of a movable structure to allow for purpose-selective change of both the first rollers 114 and second rollers 113, preferably independently of each other. Once a specific pattern and/or profile is impressed in a surface of the sheet-like panel layer, the slab is transported downstream towards a part of the calendering stage 103 where, optionally, one or more additional layers is provided. The additional layers may be provided through one or more lamination rollers 120, arranged to provide at least one additional layer. Preferably each of the lamination rollers 120 is arranged to provide a different additional layer to a surface of the sheet-like panel layer. Three feed rollers 114 are provided such as to be able to provide a, preferably continuous, supply of the additional layer. Once one or more additional layers are provided the sheet-like panel is transported via a conveyor 116 towards a cutting stage 104. The cutting stage 104 comprises at least one cutting device 117 which is configured for cutting the sheet-like panel layer into a plurality of segments. Preferably, the dimensions, in particular the width and length of said segments substantially correspond to the dimensions of the panels to be produced. Downstream with respect to the cutting stage 104 a stacking stage 105 is provided. The stacking stage comprising a stacker for positioning the segments cut by the cutting device 117. To this end a movable frame 118 is provided with a plurality of suction elements 119. Said suction elements 119 are arranged to be placed on a surface of a segment. Once the suction elements are connected to a surface of the segment, the segment may be reallocated, such as for transport. Prior to the stacking stage 105, optionally a profiling stage (not shown) is arranged. The profiling stage may be configured for profiling at least two edges of the segments to allow different panels to be formed to interconnect. Said profiling stage may be downstream of the calendering device, preferably downstream of the cutting device 117. The bottom system 100 in this figure is identical to the top system 100 but shown from a top-view for illustrative purposes.

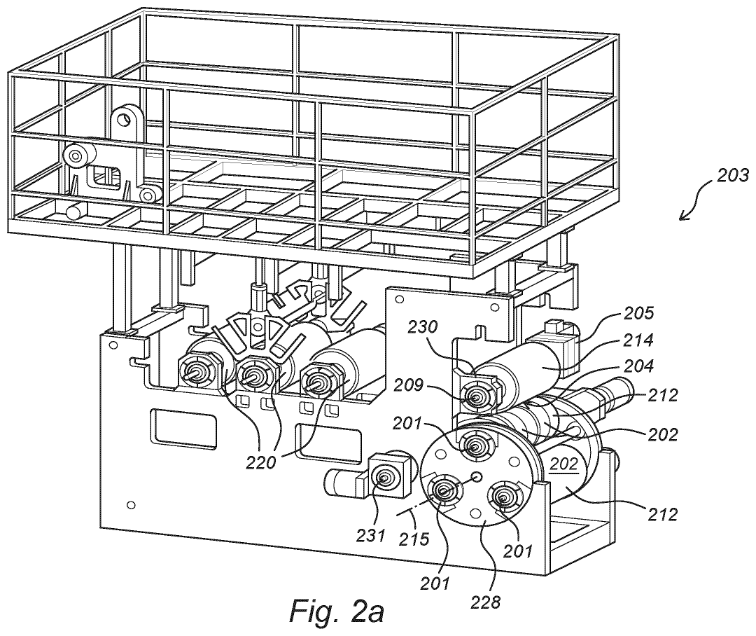

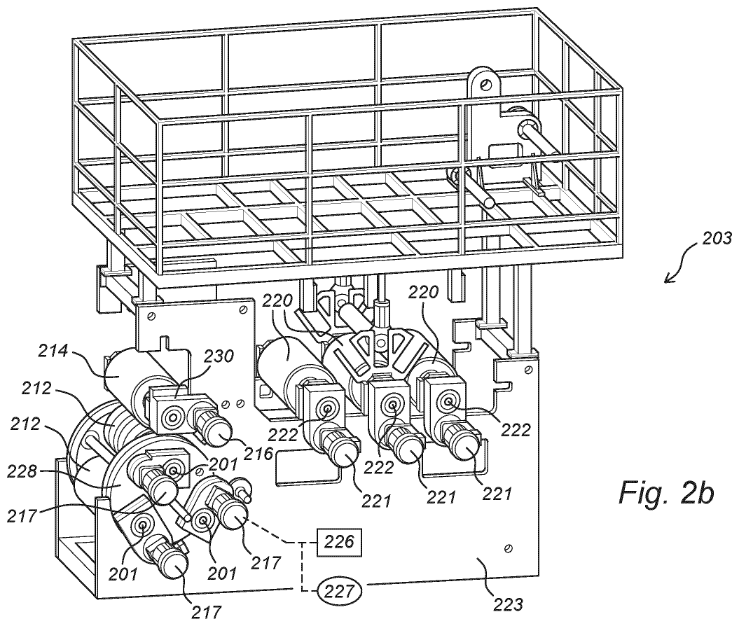

FIGS. 2a and 2b show a left and a right side of the calendering device 203 according to the present invention. The calendering device 203 comprises a first rotatable roller 214, the device 203 also comprises a plurality of second rotatable rollers 212. All components of the calendering device 203 may be mounted in a frame 223, preferably a steel frame. The first roller 214 is aligned with one of the second rollers 212, to form a nip 204 for passing through the sheet-like panel layer. The two second rollers 212 visible in FIG. 2a each comprise a different outer surface 202, wherein the aligned second roller 212 comprises a profiled outer surface in order to impress said profile into the sheet-like panel layer upon feeding said layer through the nip 204. The other second roller 212 comprises a substantially flat outer surface. In case no profiling of the sheet-like panel layer is required, the alignment of the rollers 214, 212 may be altered such that the second roller 212 with the flat outer surface 202 is aligned with the first roller 214. This may be achieved by, in this particular figure, rotating the second mounting structure 228 counter clockwise around its rotational axis 215, until the smooth second roller 212 is aligned with the first roller 214 and mutually form the nip 204. Preferably, each second roller 212 is rotatable around an axis of rotation 201. Although merely a single first roller 214 is shown in this embodiment, it is conceivable that the first roller 214 may be provided similar to the second rollers 212. Preferably, the second mounting structure 228 which carries the second rollers 212 is movable via a drive 231. The drive in this non-limitative embodiment is formed by an electromotor 231. However, it is also conceivable the drive 231 is pneumatic. The drive 231 is arranged to move the second mounting structure 228, for example through a transmission, which may be formed by gears. Once a specific pattern and/or profile is impressed in a surface of the sheet-like panel layer by the rollers 212, 214, the slab is transported downstream towards a part of the calendering device 203 where, optionally, one or more additional layers is provided. The additional layers may be provided through one or more lamination rollers 220, arranged to provide at least one additional layer.

Preferably each of the lamination rollers 220 is arranged to provide a different additional layer to a surface of the sheet-like panel layer.

FIG. 2b shows the other side of the calendering device 203. This side of the calendering device 203 comprises a plurality of drives 217, 216, 222 for various parts of the calendering device 203. The first roller 214 is driven by a first electromotor 216. The first electromotor 216 is mounted to the first mounting structure 230 and protrudes through a hole in said mounting structure 230 to driver the first roller 216. The motor 216 may be coupled to a shaft of the roller 214 via a transmission or be directly coupled thereto. The second rollers 212 are also driven through electromotors 217. The electromotors 217 that drive the second rollers 212 are placed at a distance from the rotational axis 201 of the second rollers 212. A transmission may be arranged between the second motors 217 and the second rollers 212 to provide a driving coupling. The second motors 217 are preferably mounted on the second mounting structure 228. This may allow the drive 217 to move together with the second mounting structure 228, such that switching the aligned pair of rollers 212, 214 does not require a reinstall of a motor. Preferably, a control unit 226 of the calendering device 203 is configured to control one or more motors 217, 216, 222 of the calendering devices. It is not required that all second motors 217 are always driven. During normal operating conditions, it may only be required to drive one of those second motors 217, in particular in order to drive the specific second roller 212 which is aligned with the first roller 214. It may furthermore be possible to provide the first roller 214 with an additional drive (not shown) in order to change the vertical position of the first roller 214, and hence allowing such motor to change the nip. The additional lamination rollers 220 are also, and in this particular embodiment each, provided with a motor 221, which is configured to rotate said additional lamination rollers 220 around an axis of rotation 222.

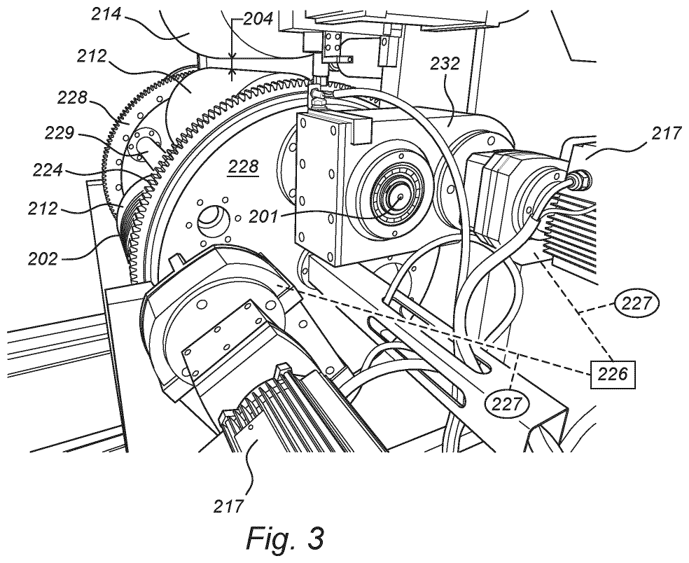

FIG. 3 shows a detail of the calendering device 203 according to the present invention. Here, a particular embodiment of the second mounting structure 228, 229 is indicated in more detail. This particular embodiment comprises a carousel frame which is formed by a two opposite rotatable discs 228, wherein said discs 228 are mounted to each other by a connecting rod 229, preferably by a number of connecting rods 229. The discs 228 may each be provided with teeth 224 along a portion of the perimeter of said discs 228. Said teeth configured to co-act with teeth of a driven other gear configured to rotate the discs around the rotational axis 215. Mounted on one disc 228 are the second electromotors 227 which are arranged to drive one or more of the second rollers 212. The non-limitative embodiment in this figure shows a transmission housing 232 which may house a transmission, such as in the form of one or more gears, to connect the output shaft of a second electromotor 227 to the drive axis 201 of a second roller 212. Said drive axis 201 may protrude through a hole in the disc. Preferably, a control unit 226 is communicatively connected to one or more (second) electromotors 227, in order to control the drives 227. That is, in this figure, merely the top second roller 212 is required to be driven in order to force a sheet-like panel layer through the nip 204 between the first roller and the second roller 212. Here, the aligned pair of rollers 212, 214 both have a substantially smoot outer surface. Hence, the sheet-like panel layer passing through the nip 204 will be substantially smooth on its upper and lower surfaces. The other second roller 212 on the second mounting structure 228, 229, comprises at least one profiled section 202, wherein the profile here is formed by tracks. Although the particular embodiment shown and described in this figure is formed by a second mounting structure 228, 229, formed by discs 228 and a connecting rod 229, alternatives to achieve the same are possible. For example, instead of the second mounting structure to function as a carousel, a linearly displaceable set of second rollers 212 is also conceivable. To this end, the two opposite discs 228 may be formed by, e.g., opposite beams or opposite linear frame parts. The teeth 224 on the perimeter of the disc 228 may in such a linear embodiment function as a rack and pinion system to achieve the displacement of second rollers 212. Yet another alternative arrangement may comprise a plurality of second mounting structures, for example wherein each is oriented to one position, said position corresponding to the aligned position of the first roller 214 and second roller 212. A specific second roller 212 may be raised (such as pneumatically, or electrically, or robotically) to be placed in the aligned position. The invention is therefore not limited to the specific embodiment shown in the figure(s).

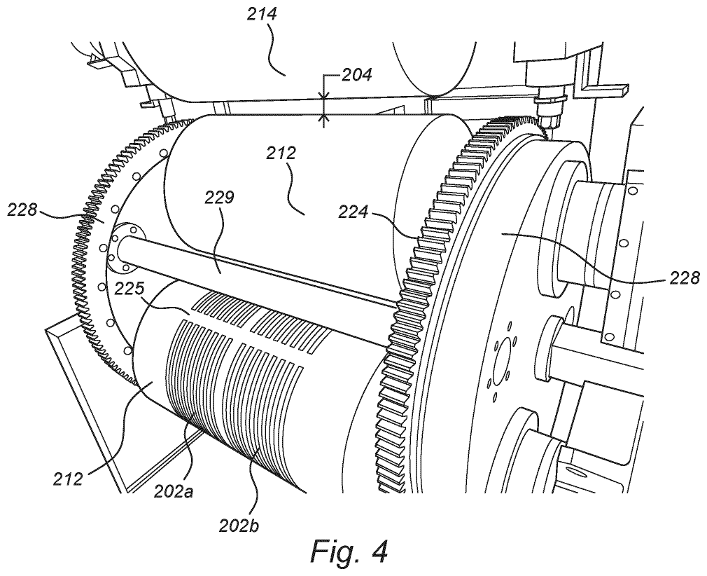

FIG. 4 shows a perspective view of an upstream side of a part of the calendering device 203 according to the present invention. This view provides a good view towards the different second rollers 212. Here the second mounting structure 228, 229 is also formed by two opposite discs 228 connected through a connecting rod 229. Between the discs 228 the second rollers are arranged. By rotating the second mounting structure 228, 229, for example by an external drive that co-acts with the teeth 224 along the perimeter of the discs 228, the second roller 212 that is aligned with the first roller 214 may be changed. Here, the currently aligned second roller 212 has a substantially smooth outer surface. The other second roller 212 is provided with a profiled outer surface 202. On this second roller, two profiled sections 202a, 202b are provided. Preferably, the width of at least one, in particular each of the sections 202a, 202b corresponds to a width smaller than the ultimate width of a panel to be produced. In particular, the width of the section 202a, 202b is preferably about 0.5-6.0 cm smaller than the width of a panel to be produced, in particular in case the panel layer thickness is below 5 mm. Preferably said sections 202a, 202b are centrally placed on a panel to be produced, in particular at a distance from the edges. This is in particular since the edges of the panels may comprise one or more coupling profiles which tend to be a more fragile portion of the panel. Therefore, impressing a profile, such as sections 202a, 202b, may affect the strength of the panel locally. Therefore, it is preferred that the width of the profiled sections 202a, 202b on the outer surface of the second roller 212 is smaller than the width of a panel. As such it is possible to maintain the strength around the edges of a panel. The same is preferred in the lengthwise orientation of a panel. Therefore, the profiled sections 202a, 202b are not continuously extending around the perimeter of the second roller 212, but a small interruption 225 in provided 202 in the circumferential direction. This interruption 225 in the profiled sections 202a, 202b prevents that the impressed parts do not extend all the way along the length of a panel. Also, said interruption 225 may be utilized by the cutting section as an indicated for the cutting location. The diameter of the second roller 212 is preferably not arbitrarily chosen. Preferably, the outer diameter of a second roller 212 is slightly larger compared to the length of a panel to be produced. Preferably, the width of a second roller 212 is at least twice, preferably more than twice, as wide as the width of the panel to be produced. It is of course also possible to imagine that the outer diameter of the second roller 212 is slightly larger than twice the length of a panel to be produced. This however also means two interruptions 225 in the circumferential direction are provided. Any double thereof is naturally also possible, however, less preferred in view of the significantly large diameter and hence weight increases of the second rollers 212.

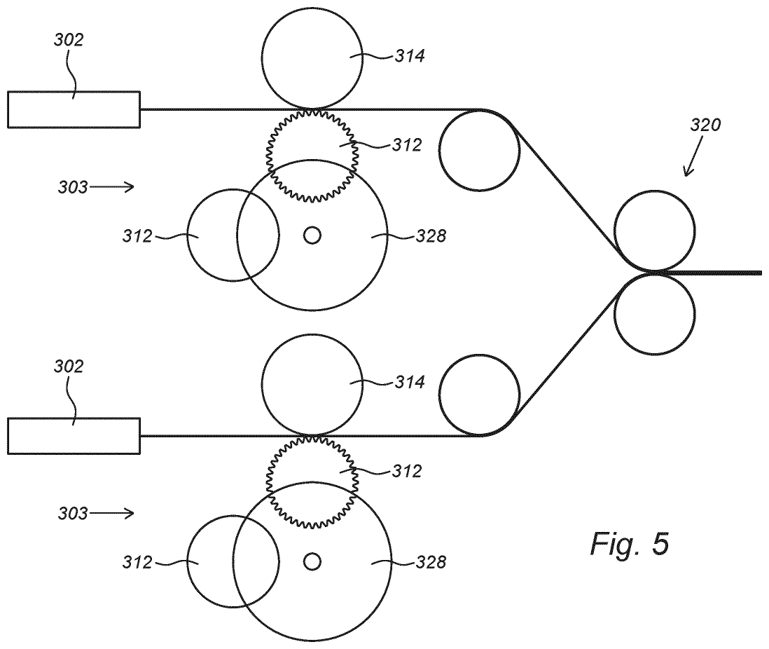

FIG. 5 shows a schematic representation of a different embodiment of the present invention. Here, the application of the calendering device 303 according to the present invention is used in a co-extrusion process to obtain beneficial results. In this embodiment, two extruders 302 are provided, each extruder for providing a layer of sheet-like panel layer. The layers may be the same, or mutually differ in for example composition. Each extruder 302 provides said sheet-like panel layer towards a calendering device 303 according to the present invention. Each calendering device 303 is here provided with a first roller 314, which may be mounted on a first mounting structure (not shown). Also, a plurality of second rollers 312 are rotatably mounted on a second mounting structure 328. Here, both calendering devices 303 are according to the present invention. However, it may suffice if only one of the calendering devices 303 shown here is according to the invention. On both calendering devices 303, currently a profiled roller 312 is selected, both for impressing a profile on the sheet-like panel layers. Both sheet-like panel layers are carried towards a fusing roller 320, which mutually fuses, for example under application of heat, the two sheet-like panel layers to form a single panel layer. Through this embodiment, it is possible to profile both the bottom side of the panel to be formed as well as enclosing interior cavities in the panel to be formed. This may be of benefit for example to save weight.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application. It is, for example, imaginable that the invention of impressing core grooves and/or an alternative 3D pattern in an upper side and/or lower side of a core, in particular by means of calendering, may also be used to create light-weight panels, in particular floor panels, which are not provided with coupling profiles at all or which are provided with only two complementary coupling profiles located at opposite panel edges. In this alternative panel configuration, the decorative structure will typically be affixed, either directly or indirectly, to an upper side of the core. This alternative panel may be used for example as floor panel, wall panel, and/or ceiling panel. Various embodiments of the panel as described above and in the appended claims may be combined with this alternative panel configuration.

By “horizontal” is meant a direction which extends parallel to a plane defined by the floor panel, and which may intersect the core. By “vertical” is meant a direction which is perpendicular to said plane defined by the floor panel. The ordinal numbers used in this document, like “first”, “second”, and “third” are used only for identification purposes. Hence, the use of the expressions “third locking element” and “second locking element” does therefore not necessarily require the co-presence of a “first locking element”.

By “complementary” coupling profiles is meant that these coupling profiles can cooperate with each other. However, to this end, the complementary coupling profiles do not necessarily have to have complementary forms. The “floor panel” according to the invention may also applied as wall covering element, ceiling covering element, or alternative covering element. In case in this document reference is made to a “floor tile” or “floor panel”, these expressions may be replaced by expressions like “tile”, “wall tile”, “ceiling tile”, “covering tile”.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1-46. (canceled)

47. A system for producing panels at least partially, said system comprising:
at least one calendering device for calendering a sheet-like thermoplastic based panel layer of at least one panel to be produced, said panel layer having first and second opposed major surfaces, wherein said calendering device comprises:
at least one first axially rotatable roller mounted by a first mounting structure,
a plurality of second axially rotatable rollers, mounted by at least one second mounting structure,
wherein at least a part of said first mounting structure and at least a part of said at least one second mounting structure are mutually displaceable to align a selective second roller with said first roller, such that a roller nip is enclosed by said aligned rollers, whereby passage of said panel layer through said roller nip causes calendering of said panel layer, and
wherein at least one second roller has a profiled outer surface to impress a corresponding pattern into the second major surface of the panel layer, and
wherein each second roller is connected to at least one second electromotor for axially rotating said second roller.
wherein the at least one second mounting structure comprises an axially rotatable carousel frame mounting the plurality of second axially rotatable rollers;
wherein the carousel frame is positioned underneath the first roller, such that an uppermost second roller mounted by said carousel and said first roller define the roller nip.

48. The system according to claim 47, wherein at least two second rollers have a profiled outer surface, wherein the profiled outer surfaces of said second rollers mutually differ.

49. The system according to claim 47, wherein at least one profiled outer surface of at least one second roller comprises at least one impression pattern.

50. The system according to claim 49, wherein the length and/or width of each panel to be produced based upon said panel layer exceeds the length and/or width of each impression pattern.

51. The system according to claim 47, wherein at least one profiled outer surface of at least one second roller comprises at least one set of plurality of parallel recessed and/or protruding tracks.

52. The system according to claim 47, wherein at least one profiled outer surface of at least one second roller comprises at least one matrix and/or honeycomb based profile.

53. The system according to claim 47, wherein at least one profiled outer surface of at least one second roller comprises at least one profiled surface section and at least one unprofiled surface section.

54. The system according to claim 47, wherein the circumference of at least one profiled second roller is substantially equal to n times the length of a panel to be produced, wherein n≥1.

55. The system according to claim 47, wherein at least one second roller has a completely unprofiled outer surface to smoothen the second major surface of the panel layer.

56. The system according to claim 47, wherein at least two second axially rotatable rollers are mounted by the same second mounting structure.

57. The system according to claim 47, wherein at least one second mounting structure is configured to displace at least one second roller between (i) an aligned position with respect to said first roller, such that said roller nip is enclosed by said aligned rollers, and (ii) an idle position wherein said second roller does not contribute to the calendering of the panel layer.

58. The system according to claim 47, wherein the carousel frame comprises opposite rotatable discs, wherein the second rollers are positioned in between said discs and mounted by said discs.

59. The system according to claim 58, wherein at least one disc is configured as gear wheel which co-acts with a carousel electromotor driven other gear wheel for rotating the carousel frame.

60. The system according to claim 47, wherein at least one first roller co-acts and/or is configured to co-act with at least one first electromotor for axially rotating said first roller.

61. The system according to claim 47, wherein the calendering device is configured to change the height position of the first roller and/or of the first mounting structure to allow adjustment of the height of the roller nip between the first roller and at least one second roller.

62. The system according to claim 47, wherein the first roller and the facing second rollers are actively driven rollers.

63. The system according to claim 47, wherein at least one first roller and/or at least one second roller comprises at least one heating element for heating the outer surface of said roller.

64. The system according to claim 47, wherein the system comprises at least one additional panel layer, and wherein the calendering device is configured to laminate said sheet-like thermoplastic based panel layer with said additional panel layer.

65. The system according to claim 47, wherein the system comprises at least one extruder positioned upstream with respect to said calendering device, wherein said extruder is configured to produce said sheet-like thermoplastic based panel layer.

66. The system according to claim 47, wherein the system comprises at least one printing station positioned downstream with respect to said calendering device, wherein said printing station device is to provide said sheet-like thermoplastic based panel layer with at least one decorative and/or protective print layer.

67. The system according to claim 47, wherein the system comprises at least one cutting device positioned downstream with respect to said calendering device, wherein said cutting device is configured to cut said sheet-like thermoplastic based panel layer into a plurality of segments having a length and width which substantially corresponds to a length and width of the panels to be produced.

68. The system according to claim 47, wherein the system comprises at least one profiling device positioned downstream with respect to said calendering device, wherein said profiling device is configured to profile at least two edges of said sheet-like thermoplastic based panel layer to allow the panels to be formed to interconnect.

69. The system according to claim 47, wherein the profiled outer surface of at least one second roller is provided with a plurality of protrusions, wherein at least 50% of said protrusions have a height of between 0.05 and 2 mm.

70. A calendering device for use in a system according to claim 47.

71. A method of producing panels at least partially by using the system according to claim 47, said method the steps of:
A) selecting a second axially rotatable roller out of a plurality of second axially rotatable rollers for the purpose of calendering a panel layer, wherein said second axially rotatable roller is mounted by a second mounting structure,
B) aligning a first axially rotatable roller mounted by a first mounting structure with the selected second axially rotatable roller by, if needed, mutually displacing said first mounting structure and said second mounting structure, such that a roller nip is enclosed by said aligned rollers,
C) guiding a sheet-like thermoplastic based panel layer through said roller nip, and
D) forcing at least one of said aligned rollers to axially rotate resulting in calendering of the panel layer, wherein during this step a pattern is impressed into a major surface of the panel layer by a profiled outer surface of the selected second roller;
wherein the at least one second mounting structure comprises an axially rotatable carousel frame mounting the plurality of second axially rotatable rollers;
wherein the carousel frame is positioned underneath the first roller, such that an uppermost second roller mounted by said carousel and said first roller define the roller nip.

72. The method according to claim 71, wherein during step C) the panel layer is in a viscous, deformable state.

73. A panel comprising a panel layer having at least one impressed major surface by using the system according to claim 47.
